(19) United States
(12) Patent Application Publication
(10) Pub. No.: US 2017/0058601 A1
(43) Pub. Date: Mar. 2, 2017

(54) STABILIZED ROPE LADDER

(71) Applicant: Robert M. Salvarezza, Hillsborough, CA (US)

(72) Inventor: Robert M. Salvarezza, Hillsborough, CA (US)

(21) Appl. No.: 14/838,047

(22) Filed: Aug. 27, 2015

(51) Int. Cl. E06C 1/56; E06C 7/08; B63B 27/14

(52) U.S. Cl. CPC E06C 1/56; B63B 27/146; E06C 7/08

(57) ABSTRACT

This invention relates to a stabilized rope ladder comprising stabilizing steps that are lengthwise extensions of normal rope ladder steps and which further comprise a strength-enhancing metal scaffold enclosed in a polymeric composition.

### BACKGROUND

The following is provided as background information only. Nothing in this section is intended to be, nor should it be construed as, prior art to the subject invention.

Rope ladders have many uses. For example they can serve as emergency escape means from buildings, ships at sea and other elevated structures. They are also useful as boarding and disembarking means for ships. In particular, rope ladders are the default means for harbor pilots to board ships to take control of bringing the ships safely into dock. To ensure to the extent possible the safety of rope ladders for marine use, the U.S. Coast Guard has mandated specific requirements for the construction of such rope ladders. Numerous patents have been issued directed to rope ladder construction that meet or exceed Coast Guard specifications.

One of the earliest patents relating to rope ladder construction that comports with Coast Guard regulations is U.S. Pat. No. 4,117,878, filed on 14 Aug. 1978 and issued on 11 Dec. 1979. Historically, rope ladder steps were made of wood. Wood steps, however, are susceptible to warping, breakage and general structural non-uniformity. The advent of superior strength polymers led to the development of steps made of tough, durable polymeric materials. Thus, U.S. Pat. No. 4,241,809, filed on 13 Aug. 1979 and issued on 30 Dec. 1980, was directed to rope ladders incorporating molded elastomer steps and to methods of assembling rope ladders having such steps. U.S. Pat. No. 4,554,996, filed on 12 Apr. 1985 and issued on 26 Nov. 1985 was directed to improvements to the polymeric steps and to methods of replacing polymeric steps and the collars that secure the steps to the side ropes of the ladder. U.S. Pat. No. 4,655,321, filed on 29 Aug. 1986 and issued on 7 Apr. 1987, was directed to an improved method for assembling rope ladders comprising molded polymeric steps. U.S. Pat. No. 4,683,981, filed on 4 Aug. 1986 and issued on 4 Aug. 1987, was directed to added beneficial features for molded elastomeric steps, to replacement and spreader steps and to novel methods of molding the steps. More recently, U.S. Pat. No. 6,902,037 was filed on 2 Sep. 2003 and was issued on 7 Jun. 2005. The '037 patent is directed to a device for securing the steps of a rope ladder to the side ropes. Each of the foregoing patents was issued to Robert. M. Salvarezza, the inventor in the present application, and each of the above patents is incorporated by reference, including all drawings, as if fully set forth herein.

An important aspect, and a necessary one for pilot ladders under Coast Guard regulation, is the stability of rope ladders when deployed. Since the ropes are, naturally, flexible, rope ladders tend to move, particularly to twist, when deployed. To counter this movement, rope ladders may—and in the case so-called “pilot ladders subject to Coast Guard regulations, must—employ outriggers that extend outward in each direction from the side ropes essentially parallel to the steps of the ladder and that abut the surface of whatever object the rope ladder is adjacent to, thereby stabilizing the rope ladder. In some formats the outriggers are extended portions of the steps themselves.

A problem with separate outriggers or extended steps is their longevity since they are especially prone to wear and tear during use. For instance, since they extend beyond the main bulk of a rope ladder when not deployed, they make a convenient handhold for lifting and carrying the ladder. The heavy weight of the rope ladder that is being borne by the extended steps renders them susceptible to damage, even breakage necessitating replacement, which may render the rope ladder unsafe, perhaps even unusable when most critically needed. What is needed is a stabilized rope ladder comprising stabilizing steps that are capable of handling normal uses and even misuse while still retaining the structural integrity necessary to properly perform their function. This invention provides such a stabilized rope ladder.

### SUMMARY

Thus, in one aspect the present invention relates to a stabilized rope ladder, comprising:
a plurality of molded polymeric normal steps, each normal step having a length, two lengthwise edges, a width, two slots perpendicular to the lengthwise edge of the step, one proximate to each end of the length; a side rope securing assembly associated with each slot and two first tubular elements encased in the molded polymer, each having two ends, one tubular element extending the length of the step proximate to one lengthwise edge of the step and the other extending the length of the other lengthwise step edge proximate to that edge wherein each end of the first tubular elements terminates a distance outward from the slot/rope-securing assembly, the first tubular elements being coupled to flanges of the rope securing assembly;
two side ropes passing through each slot, the ropes being secured to the steps by the side rope securing assemblies;
two or more molded polymeric stabilizing steps interspersed at intervals between the normal steps, the stabilizing steps comprising lengthwise extended normal steps, the stabilizing steps comprising a metal support scaffold encased in the molded polymer, wherein the metal scaffold comprises:
   two second tubular elements, each being U-shaped, one of which traverses the perimeter of the extended step to one side and the other of which traverses the perimeter of the extended step to the other side of the slot/rope securing assembly such that the two ends of each U are fitted into the two first tubular elements and extend for a distance inward of the slot/side rope securing assembly;
   two third tubular elements, each of which has two ends, one of the third tubular element being fitted over one of the second tubular elements and the other being fitted over the other second tubular element such that the ends of the third tubular elements extend in both directions beyond the rope securing assembly.

In an aspect of the present invention, the three tubular elements and the flanges of the rope securing assembly are coupled by a bolt inserted in aligned through-holes in each tubular element and the flange at both ends of the rope securing assembly, the bolt being secured by a nut.

In an aspect of this invention, the metal support scaffold tubular elements are rectangular in cross-section.

In an aspect of this invention, the metal scaffold tubular elements are square in cross-section.

In an aspect of this invention, the normal steps are at least 19 inches in length.

In an aspect of this invention, the stabilizing steps are at least 70 inches in length.

In an aspect of this invention, all steps, normal and stabilizing, are uniformly disposed 12 to 15 inches apart.

In an aspect of this invention, all steps, normal and stabilizing, are uniformly disposed 12¼ inches apart.

In an aspect of this invention, at least every 9^{th} step is a stabilizing step.

In an aspect of this invention, the polymer comprises polyurethane.

In an aspect of this invention, the polymer is a polymeric composite.

In an aspect of this invention, the polyurethane comprise a polyurethane composite.

In an aspect of this invention, the metal of the metal support scaffold comprises iron, steel, aluminum or alloys of any of the aforesaid.

An aspect of this invention is a pilot ladder comprising a stabilized rope ladder of this invention.

### Detailed Disclosure

### BRIEF DESCRIPTION OF THE FIGURES

The figures are provided for illustrative purposes only to assist in understanding the invention herein and are not intended nor should they be construed as limiting the scope of this invention in any manner. The figures are not necessarily to scale. Some elements of the invention are shown spaced apart for convenience in viewing even though in an actual rope ladder of this invention those elements would be contiguous. The use of the same number in different drawings herein to identify an element of a device means that that element is the same in both drawings.

FIG. 1 is an illustration of a portion of a non-stabilized rope ladder.

FIG. 2 is a schematic representation of a normal step of a rope ladder of this invention.

FIG. 3 is an illustration of a portion of a stabilized rope ladder of this invention.

FIG. 4A is a top view of a stabilizing step of this invention.

FIG. 4B is a cross-sectional view of the metal support scaffold of a stabilizing step of this invention.

FIG. 5 is an illustration of the metal scaffold of a stabilizing step of this invention with the step and the rope-securing assembly removed.

### DISCUSSION

It is understood that, with regard to this description and the appended claims, any reference to any aspect of this invention made in the singular includes the plural and vice versa unless it is expressly stated or unambiguously clear from the context that such is not intended.

As used herein, any term of approximation such as, without limitation, near, about, approximately, substantially, essentially and the like, means that the word or phrase modified by the term of approximation need not be exactly that which is written but may vary from that written description to some extent. The extent to which the description may vary will depend on how great a change can be instituted and have one of ordinary skill in the art recognize the modified version as still having the properties, characteristics and capabilities of the word or phrase unmodified by the term of approximation. In general, but with the preceding discussion in mind, a numerical value herein that is modified by a word of approximation may vary from the stated value by ±10%, unless expressly stated otherwise.

As used herein, the use of “preferred,” “presently preferred,” “More preferred,” “preferably,” and the like refers to preferences as they exist at the time of filing of this application.

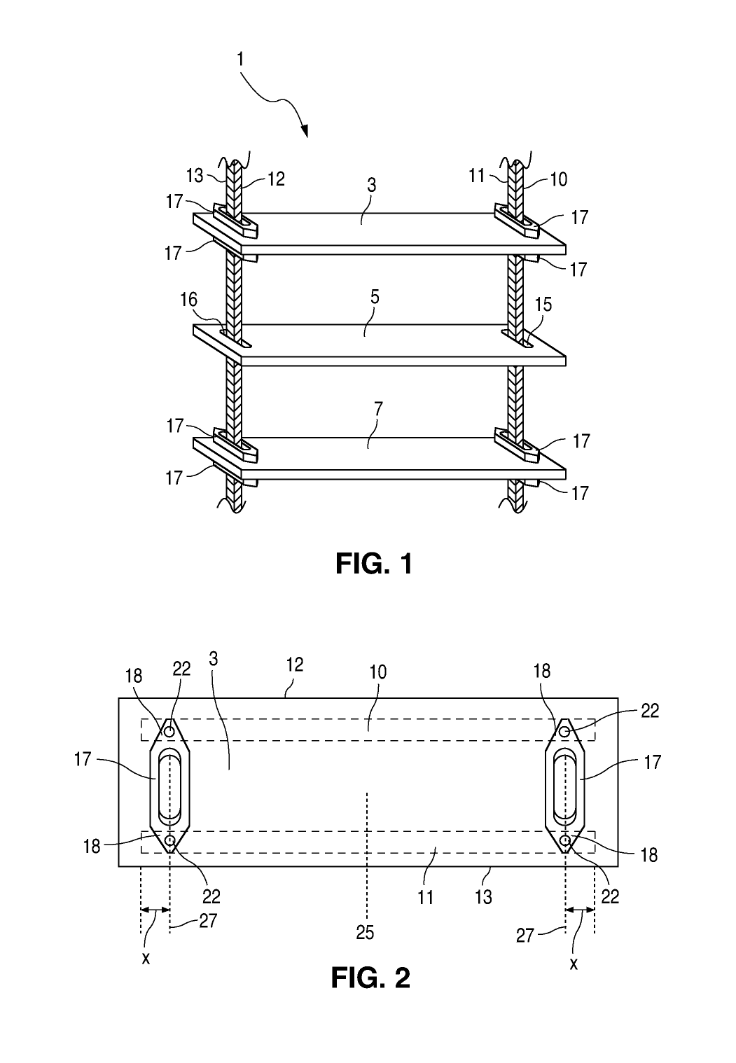

As used herein, a “rope ladder” has the conventional meaning as would be generally understood to those skilled in the art. That is, a rope ladder comprises two sets of two ropes, generally referred to in the art as “side ropes,” which two sets of side ropes are essentially parallel and are separated by a series of steps which are coupled to the ropes at each end of the step. A portion of a typical rope ladder is shown in FIG. 1. In FIG. 1, rope ladder 1 comprises steps 3, 5, and 7, side ropes 10, 11, 12 and 13, which are paired off and passed through slots 15 and 16, shown only for step 5. Associated with the slots are rope-securing assemblies 17, shown for steps 3 and 7, which rope-securing assemblies clamp the ropes in place and prevent the steps from slipping. The steps in FIG. 1, which steps extend only a relatively short distance beyond the side ropes/side rope-securing assemblies are referred to herein as “normal steps.”

FIG. 2 is a top view of normal step 3, remaining steps 5 and 7 being essentially the same as step 3 is all structural aspects. Step 3 is fabricated of a polymeric material. Presently preferred is polyurethane. The step can be fabricated using any suitable molding process. At present, reaction injection molding is preferred. Other polymers can, of course be used so long as they have at least the same physical properties as a polyurethane step. The steps may be fabricated of one polymer or a blend of polymers. In addition, a polymeric composite, that is a polymer or blend of polymers comprising, in addition to the polymer(s), a filler such as, without limitation, fiberglass or carbon fibers.

Encased in polymeric step 3 are first tubular elements 10 and 11. First tubular element 10 runs essentially parallel to long edge 12 of step 3 and tubular element 11 runs parallel to long edge 13 of step 3. Each of first tubular elements 10 and 11 extend a distance x outward, that is, away from center line 25 of step 3, beyond center line 27 of slot/rope securing assemblies 17. First tubular elements 10 and 11 are secured to flanges 18 of rope-securing assemblies 17 by bolts 22, which pass through the flanges and the first tubular elements.

The phrase “a distance [outward/inward] from” is used herein to designate the spatial relationship between two elements of this invention. An exact distance has not been disclosed in any such instance for the simple reason that such distance is variable depending on the expected use of a stabilized rope ladder and the required strength of the stabilizing steps. Thus, “a distance” may refer to a fraction of an inch or to several inches. Those skilled in the art will be able to empirically determine suitable lengths of “a distance.”

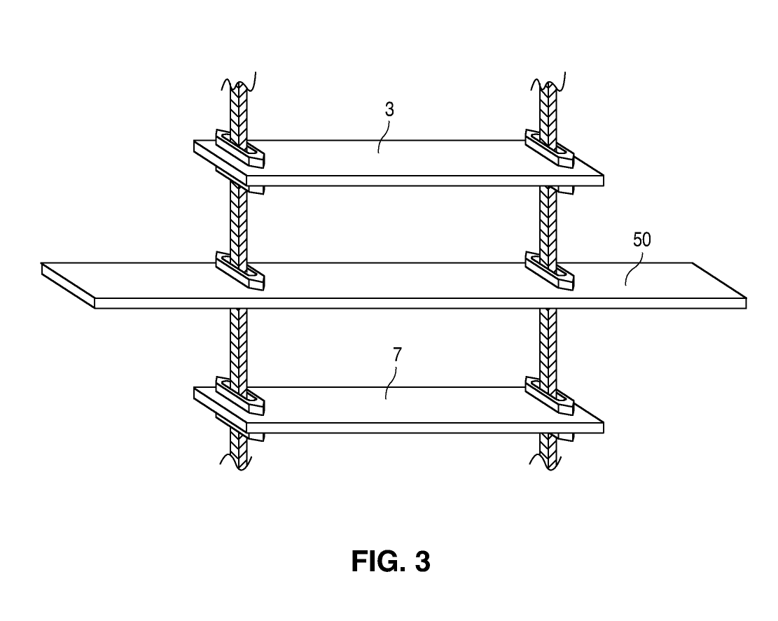

As used herein, a “stabilized rope ladder” refers to a rope ladder that includes stabilizing steps comprising an extension projecting outward from each end of the length of a normal step. The step extensions will rest against whatever surface the rope ladder is adjacent to and will provide a buffer against movement of the ladder when subjected to forces such as wind and, in the case of marine use, the movement of water when a ship is at sea or moored. A portion of a stabilized rope ladder is shown in FIG. 3. In FIG. 3, steps 3 and 7 are “normal steps” as describe above. Step 50, on the other hand, is a “stabilizing step.”

The use of stabilizing steps, sometimes referred to as spreader steps or battens is well established in the maritime use of rope ladders. In fact, such stabilized rope ladders are mandated by the Coast Guard for use in boarding and disembarking from ships by pilots, those sailors who specialize in the docking of ships once in a harbor. The Coast Guard has placed very stringent criteria on the properties of such so-called “pilot ladders.” One of these criteria is that they must be able to withstand a minimum of 750 lbs of weight at the center of the stabilizing step with no more than a ¾ inch deflection from planar. It is at the crux of this invention that stabilizing steps disclosed herein exceed the Coast Guard mandate by a substantial margin, that is, under Coast Guard required testing conditions, a stabilizing step of this invention exhibits virtually no measurable deflection.

It is noted that, if a third tubular element hereof is placed over the first tubular element in normal steps in the same manner as it is placed over the first and second tubular elements in a stabilizing step, the normal step likewise exhibits, that is, absent the extension of a normal step that comprises the second tubular element, the normal step, when subjected to the above mentioned Coast Guard testing procedure, likewise exhibits no measurable deflection.

“Tubular” has the meaning usually associated with it, that is, an elongate hollow construct. However, as used herein, the cross-sectional shape of the tube need not be circular but may be oval, rectangular, square, or multi-sided as well. It is presently preferred, however, that a tubular element of this invention be rectangular, most preferably square, in cross- section. As such, each tubular element herein has an inner surface that define the lumen of the tube, an outer surface and a thickness between the inner and outer surfaces. These parameters are described below in conjunction with the disclosure of the elements of a stabilizing step of this invention.

The rope-securing assembly may be any known in the trade as well as any that may become known in the future but it is presently preferred that the rope securing assembly be that described in detail in U.S. Pat. No. 6,902,037 to Salvarezza, filed on 2 Sep. 2003 and issued on 7 Jun. 2005, which patent is incorporated herein in its entirety, including drawing, as if it were fully reproduced in this disclosure.

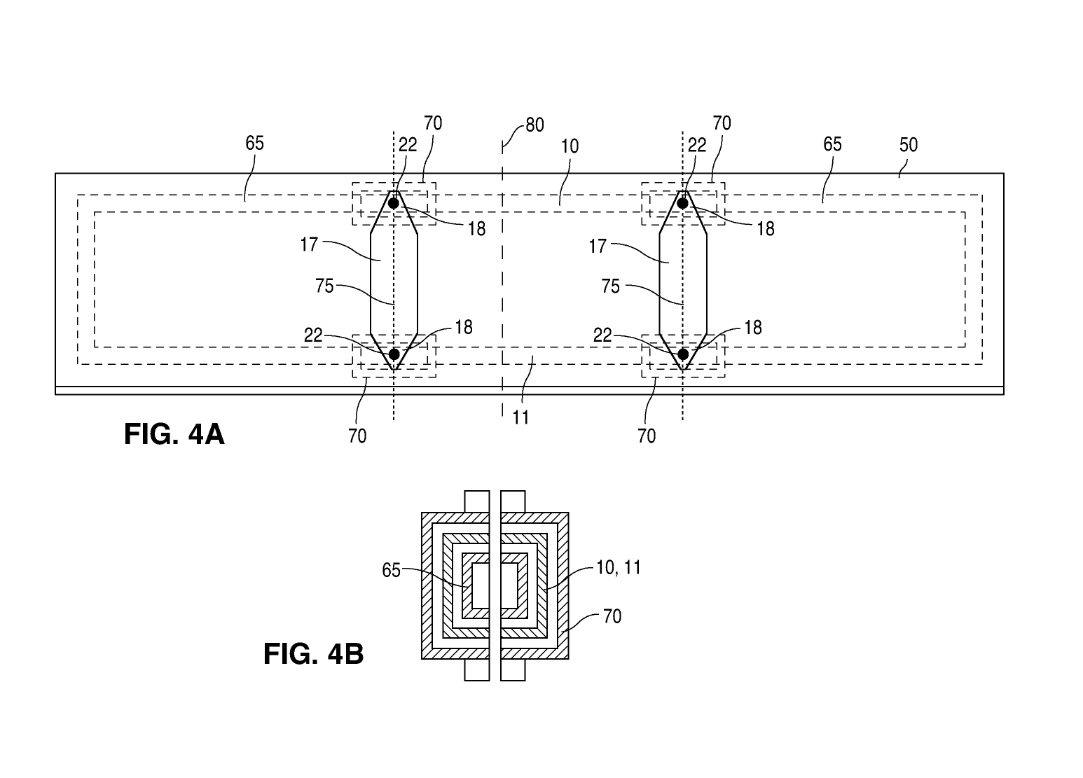

FIG. 4 shows stabilizing step 50 in detail. The metal scaffold over which polymeric stabilizing step 50 is molded is the key to the extreme strength of the step. FIG. 4A is a top view of polymeric step 50, while FIG. 4B is a cross-section of step 50 at line “a.” Embedded in step 50 are first tubular elements 10 and 11, which are the same as first tubular elements 10 and 11 in FIG. 2. Also embedded in step 50 are U-shaped second tubular elements 65. The ends of second tubular elements are inserted into first tubular elements 10 and 11 for a distance inward, that is, toward center line 80 of step 50, from center lines 75 of rope-securing assemblies 17. Finally, third tubular elements 70 are situated over first tubular elements 10 and 11. This construct can be more easily seen in FIG. 4B wherein a cross-section at the center line of either rope-securing assembly 17 is shown. In FIG. 4B, second tubular 65 is shown within first tubular element 10 (or 11 as the construct is the same at both rope-securing assemblies) and third tubular elements 70 are shown as the outer element of the construct. The tubular elements are shown separated by an apparent open space but such is not in reality the case. The dimensions of each of the tubular elements are such that the outer surface of tubular element 65 is contiguous with the inner surface of tubular elements 10 and 11, the outer surfaces of which are contiguous with the inner surface of tubular element 70. All tubular elements 10, 11, 65 and 70 are bolted to rope securing elements 17 with bolts 22 which pass through holes drilled in each tubular element and flanges 18 of rope-securing assemblies 17.

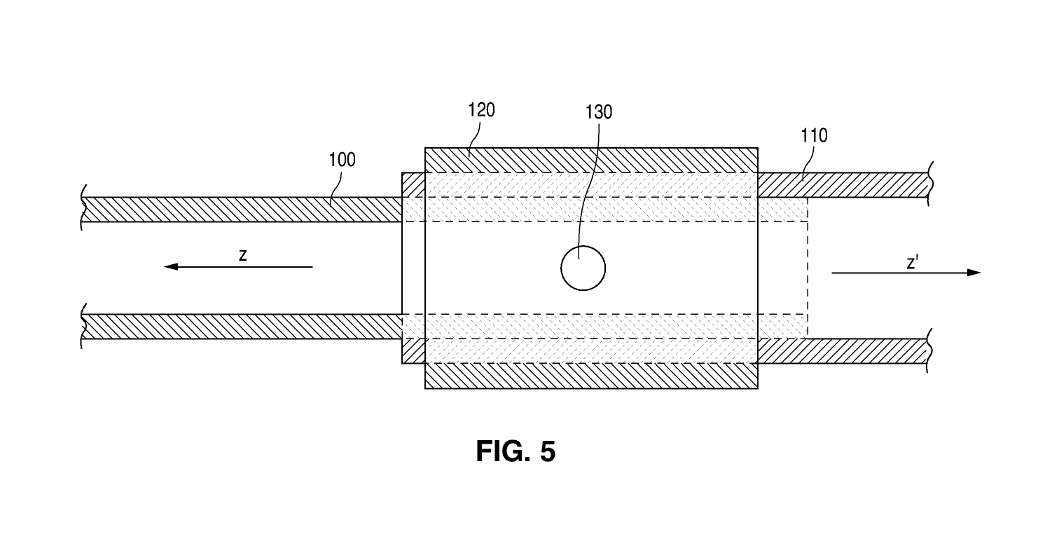

In FIG. 5, is an enhanced view of the tubular metal scaffolding in the vicinity of the rope-securing assembly. The direction z′ is toward the center of the step and direction z is toward the horizontal edge of the step. As can be seen, second tubular element 100 is inserted into first tubular element 110 and third tubular element 120 is situated over first tubular element 110. Circular hole 130 is drilled through each of the tubular elements and the flange of a rope-securing assembly (not shown) through which a bolt is passed to secure all the features, the tubular elements and the rope-securing assemblies, together.

### EXAMPLE

With regard to a stabilized rope ladder for use as a pilot ladder, the following dimensions, which meet Coast Guard regulations for such ladders can be used. The length of the normal steps in the pilot ladder is no less than 19″ and the width is no less than 4½″. The step must be at least 1″ thick, excluding any anti-slip surfacing material on the step. The length of a stabilizing step is no less than 70″, the width and thickness being the same as a normal step. All steps, normal and stabilizing, should be equally spaced no less than 12 and no more than 15 inches apart. The interval between stabilizing steps must be not exceed 9 steps. Presently preferred is a distance of 12¼″ between steps, which serves to meet both the Coast Guard mandate and requirement of the International Maritime Pilots' association. The lowest stabilizing step should be the fifth step.

With regard specifically to the stabilizing steps, the tubular metal scaffolding can comprise the following dimensions:

the two first tubular elements can each be 30″ long and can be constructed of square tubular metal stock having an exterior wall dimension of 0.625″ and an interior wall dimension of 0.505″;

the two second tubular elements are U-shaped and can each be 56″ long. They can be constructed of square tubular metal stock having an exterior wall dimension of 0.5″ and an interior wall dimension of 0.380″. The ends of the second tubular elements are inserted into the first tubular elements such that the overall length of the metal scaffolding is 68″, the remaining Coast Guard required length of 70″ being provided by the molded polymer step overhang, 1″, at either end of the step;

the third tubular elements can be 3″ long and are disposed over the first and second tubular elements. They can be constructed of square tubular metal stock having an exterior wall dimension of 0.75″ and an interior wall dimension of 0.652″.

The tubular metal scaffold can constructed of any suitable metal of which iron, steel, aluminum and alloys thereof are non-limiting examples.

What is claimed is:

1. A stabilized rope ladder, comprising:
a plurality of molded polymeric normal steps, each normal step having a length, two lengthwise edges, a width, two slots perpendicular to the lengthwise edge of the step, one proximate to each end of the length; a side rope securing assembly associated with each slot and two first tubular elements encased in the molded polymer, each having two ends, one tubular element extending the length of the step proximate to one lengthwise edge of the step and the other extending the length of the other lengthwise step edge proximate to that edge wherein each end of the first tubular elements terminates a distance outward from the slot/rope-securing assembly, the first tubular elements being coupled to flanges of the rope securing assembly;
two side ropes passing through each slot, the ropes being secured to the steps by the side rope securing assemblies;
two or more molded polymeric stabilizing steps interspersed at intervals between the normal steps, the stabilizing steps comprising lengthwise extended normal steps, the stabilizing steps comprising a metal support scaffold encased in the molded polymer, wherein the metal scaffold comprises:
two second tubular elements, each being U-shaped, one of which traverses the perimeter of the extended step to one side and the other of which traverses the perimeter of the extended step to the other side of the slot/rope securing assembly such that the two ends of each U are fitted into the two first tubular elements and extend for a distance inward of the slot/side rope securing assembly;
two third tubular elements, each of which has two ends, one of the third tubular element being fitted over one of the second tubular elements and the other being fitted over the other second tubular element such that the ends of the third tubular elements extend in both directions beyond the rope-securing assembly.

2. The stabilized rope ladder of claim 1, wherein the three tubular elements and the flanges of the rope securing assembly are coupled by a bolt inserted in aligned through-holes in each tubular element and the flange at each end of the rope-securing assembly, the bolt being secured by a nut.

5. The stabilized rope ladder of claim 1, wherein the metal support scaffold tubular elements are rectangular in cross-section.

6. The stabilized rope ladder of claim 5, wherein the metal scaffold tubular elements are square in cross-section.

8. The stabilized rope ladder of claim 1, wherein the normal steps are at least 19 inches in length.

10. The stabilized rope ladder of claim 1, wherein the stabilizing steps are at least 70 inches in length.

12. The stabilized rope ladder of claim 1, wherein all steps, normal and stabilizing, are uniformly disposed 12 to 15 inches apart.

12A. The stabilizing rope ladder of claim 12, wherein all steps, normal and stabilizing, are uniformly disposed 12¼ inches apart.

13. The stabilized rope ladder of claim 1, wherein at least every 9^{th} step is a stabilizing step.

14. The stabilized rope ladder of claim 1, wherein the polymer comprises polyurethane.

15. The stabilized rope ladder of claim 1, wherein the polymer is a polymeric composite.

16. The stabilized rope ladder of claim 14, wherein the polyurethane comprise a polyurethane composite.

16. The stabilized rope ladder of claim 1, wherein the metal of the metal support scaffold comprises iron, steel, aluminum or alloys of any of the aforesaid.

17.. A pilot ladder comprising the stabilized rope ladder of claim 1.
